(19) United States
(12) Patent Application Publication
(10) Pub. No.: US 2009/0085850 A1
(43) Pub. Date: Apr. 2, 2009

(54) Liquid crystal display device with OCB mode and method dividing one frame into two sub frames for driving same

(75) Inventors: I-An Yao, Miao-Li (TW); Shu-Hui Chang, Miao-Li (TW); Hung-Lin Ko, Miao-Li (TW); Chueh-Ju Chen, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/286,355

(22) Filed: Sep. 29, 2008

(30) Foreign Application Priority Data
Sep. 28, 2007 (CN) 200710123704.8

(51) Int. Cl. G09G 3/36

(52) U.S. Cl. 345/89

(57) ABSTRACT

A liquid crystal display device that operates in optically compensated bend mode includes a gate driving circuit, a data driving circuit, and pixel units. The gate driving circuit is configured for providing a gate signal to each of the pixel units. The data driving circuit is configured for providing a first voltage corresponding to a black signal in a first sub frame of a frame divided into two sub frames to each of the pixel units via a corresponding data line, and a second voltage corresponding to a gray level display signal in a second sub frame of the frame to each of the pixel units.

### FIELD OF THE INVENTION

The present disclosure relates to liquid crystal display (LCD) devices, and more particularly to an LCD device that operates in optically compensated bend (OCB) mode and a method for driving the LCD device.

### BACKGROUND

Typical LCD devices have the advantages of portability, low power consumption, and low radiation, and have been widely used in various portable information products such as notebooks, personal digital assistants (PDAs), video cameras, and the like. However, many of these LCD devices have certain shortcomings, such as a slow response time and a narrow range of viewing angles. Thus, several kinds of LCD devices employing broad viewing angle technology f have been proposed, such as in-plane switching mode LCD devices, multi-domain vertical alignment mode LCD devices, OCB mode LCD devices, and so on.

Referring to FIG. 7, a typical OCB mode LCD device 1 includes a first substrate 11, a second substrate 12, a liquid crystal layer 13 sandwiched between the first and second substrates 11, 12, a compensation film 111, a first polarizer 112, and a second polarizer 122. The first and second polarizers 112, 122 are disposed on outer surfaces of the first and second substrates 11, 12, respectively. The compensation film 111 is disposed between the first polarizer 112 and the first substrate 11. The liquid crystal layer 13 is in homogeneous alignment.

Referring to FIG. 8, when no voltage is applied to the LCD device 1, liquid crystal molecules (not labeled) of the liquid crystal layer 13 are in a splay alignment (see part A of FIG. 8). When an OFF voltage or a transition voltage is applied to the LCD device 1, the liquid crystal molecules are rearranged from the splay alignment to a bend alignment, and maintain the bend alignment under the OFF voltage (see part B of FIG. 8). When an ON voltage or a gray level voltage between the OFF voltage and the ON voltage is applied to the LCD device 1, the liquid crystal molecules are rearranged according to the ON voltage or the gray level voltage to control transmittance of light (see, e.g., part C of FIG. 8).

FIG. 9 is a luminance-voltage graph for the LCD device 1. For a normally white (NW) LCD device 1, when no voltage or a voltage lower than the OFF voltage V_{w} is applied, the LCD device 1 displays white images. When the ON voltage V_{b} is applied, the LCD device 1 displays black images. When a gray level voltage between the OFF voltage V_{w} and the ON voltage V_{b} is applied, the LCD device 1 displays gray level images. As seen in FIG. 9, a luminance-voltage curve between the OFF voltage V_{w} and the ON voltage V_{b} is somewhat uniform. However, the luminance-voltage curve between 0V and the OFF voltage V_{w} is non-uniform, and a luminance corresponding to the OFF voltage V_{w} is far less than the highest luminance. Thus the LCD device 1 has a low luminance when displaying gray level images, and needs high gray level voltages, due to the existence of the OFF voltage V_{w}. Furthermore, although the LCD device 1 generally has a fast response time when displaying images, it needs a long warm-up time to rearrange the liquid crystal molecules from the splay alignment to the bend alignment before displaying images normally.

Therefore, an improved LCD device is needed to overcome the above-described deficiencies. A method for driving the LCD device is also needed.

### SUMMARY

An aspect of the invention relates to an LCD device that operates in optically compensated bend mode including a gate driving circuit, a data driving circuit, and pixel units. The gate driving circuit is configured for providing a gate signal to each of the pixel units. The data driving circuit is configured for providing a first voltage corresponding to a black signal in a first sub frame of a frame divided into two sub frames to each of the pixel units via a corresponding data line, and a second voltage corresponding to a gray level display signal in a second sub frame of the frame to each of the pixel units.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout the various views.

FIG. 1 is a side, cross-sectional view of part of an LCD device of a first embodiment of the present disclosure.

FIG. 2 is an abbreviated circuit diagram of the LCD device of FIG. 1, the LCD device including a plurality of pixel units.

FIG. 3 is a waveform diagram of voltage applied to one of the pixel units of FIG. 2.

FIG. 4 is a luminance-voltage graph for the LCD device of FIG. 1.

FIG. 5 is a side, cross-sectional view of part of an LCD device of a second embodiment of the present disclosure.

FIG. 6 is a side, cross-sectional view of part of an LCD device of a third embodiment of the present disclosure.

FIG. 7 is an exploded, isometric view of a conventional LCD device, the LCD device including a plurality of liquid crystal molecules.

FIG. 8 is a series of three side-plan views of the LCD device of FIG. 7, showing arrangements of the liquid crystal molecules according to three different states of the LCD device.

FIG. 9 is a luminance-voltage graph for the LCD device of FIG. 7.

### DETAILED DESCRIPTION

Reference will now be made to the drawings to describe various embodiments in detail.

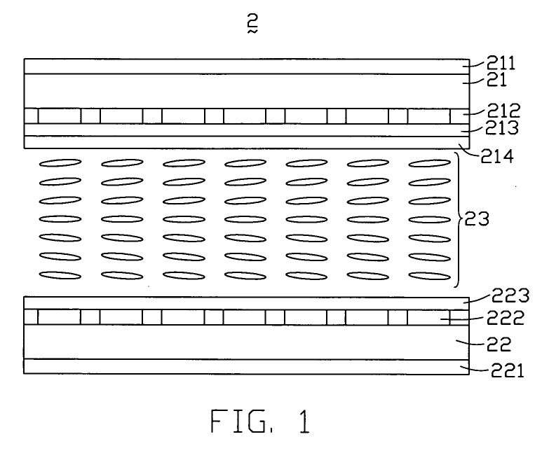

Referring to FIG. 1, an LCD device 2 of a first embodiment is shown. The LCD device 2 operates in OCB mode, and includes a first substrate 21, a second substrate 22, and a liquid crystal layer 23 sandwiched between the first and second substrates 21, 22. A first polarizer 211 is disposed on an outer surface of the first substrate 21. A color filter 212, a common electrode 213, and a first alignment film 214 are disposed on an inner surface of the first substrate 21 in that order. A second polarizer 221 is disposed on an outer surface of the second substrate 22. A pixel electrode layer (not labeled) having a plurality of pixel electrodes 222, and a second alignment film 223, are disposed on an inner surface of the second substrate 22 in that order. An alignment direction of the first alignment film 214 is parallel to that of the second alignment film 223. Thus, the liquid crystal layer 23 is in homogeneous alignment. A pretilt angle of liquid crystal molecules (not labeled) of the liquid crystal layer 23 adjacent to the first and second substrates 21, 22 is in a range from 0° to 15°. The liquid crystal molecules are positive uniaxial liquid crystal molecules.

Referring also to FIG. 2, the second substrate 22 further includes a plurality of gate lines 224 parallel to each other, a plurality of data lines 225 parallel to each other and intersecting the gate lines 224, and a plurality of thin film transistors (TFTs) 226. The grid of gate lines 224 and data lines 225 defines a plurality of pixel units 20. Each pixel unit 20 includes a pixel electrode 222 and a TFT 226. In each pixel unit 20, three terminals (not labeled) of the TFT 226 are electrically connected to a corresponding gate line 224, a corresponding data line 225, and the pixel electrode 222, respectively. A gate driving circuit 227 is electrically connected to the gate lines 224 and provides gate signals to the gate lines 224. A data driving circuit 228 is electrically connected to the data lines 225 and provides display signals to the data lines 225.

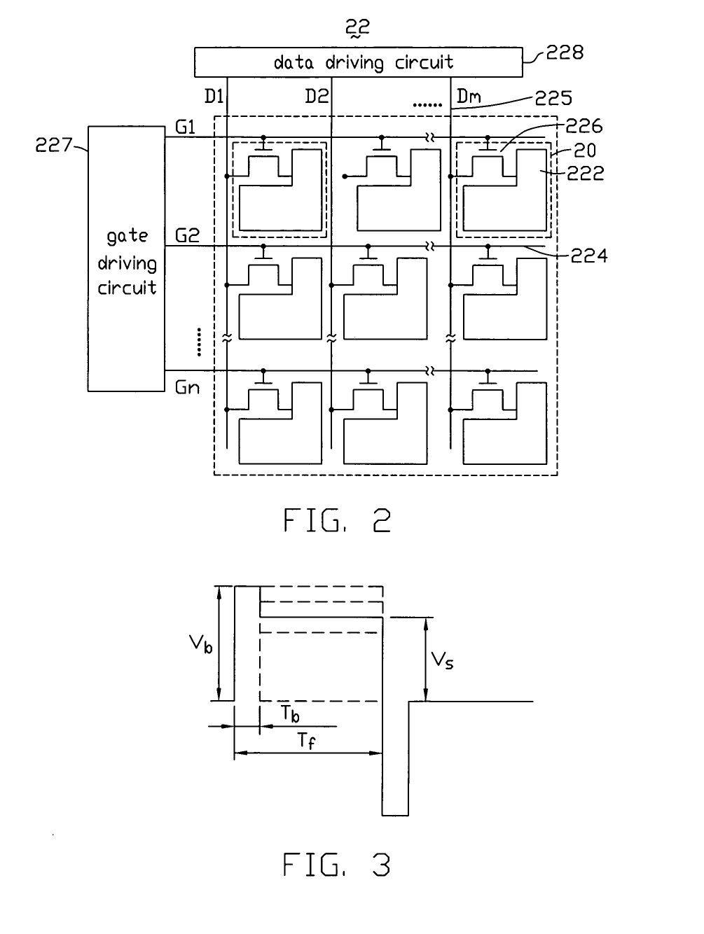

Referring to FIG. 3, a waveform diagram of voltages applied to one of the pixel units 20 is shown. When the LCD device 2 is driven to display images, each frame is divided into a first sub frame and a second sub frame. In the first sub frame, the data driving circuit 228 provides a first voltage V_{b} corresponding to a black signal to the pixel unit 20. The first voltage V_{b} is equal to an ON voltage, and the pixel unit 20 displays a black image in a first sub frame time T_{b}. In the second sub frame, the data driving circuit 228 provides a second voltage Vₛ corresponding to a gray level display signal to the pixel unit 20.

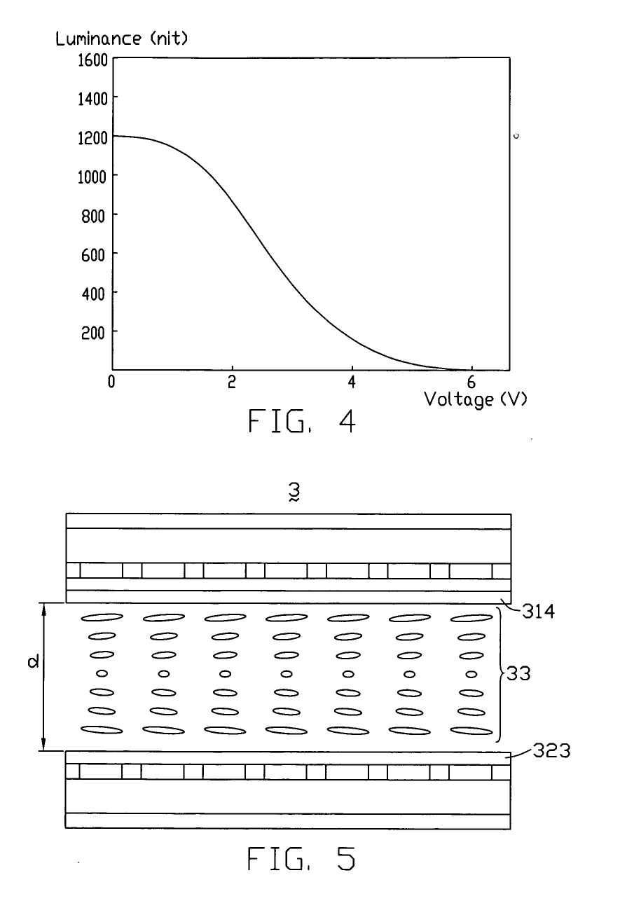

A black insertion ratio is defined as T_{b}/T_{f}, wherein, T_{f} represents a frame time. The black insertion ratio T_{b}/T_{f} is in a range from 15% to 50%. A luminance-voltage curve is typically more smooth when the black insertion ratio T_{b}/T_{f} is in a range from 15% to 30%, particularly 15% to 20%. Referring to FIG 4, a luminance-voltage graph for the LCD device 2 is shown. As seen, by applying the above driving method with a black insertion ratio of 20%, a smooth luminance-voltage curve is obtained.

In summary, the LCD device 2 employs the above driving method to divide a frame into two sub frames, and inserts a black signal in the first sub frame. Thus, a smooth luminance-voltage curve between 0V and the first voltage V_{b} is obtained. Accordingly, the second voltage Vₛ can be operated in a range from 0V to V_{b}. Therefore, an OFF voltage for the LCD device 2 is reduced, and a luminance corresponding to the OFF voltage is improved.

Referring to FIG. 5, an LCD device 3 of a second embodiment is similar to the LCD device 2, and the LCD device 3 employs the same driving method as the LCD device 2. However, a suitable amount of chiral dopant is included in a liquid crystal layer 33 of the LCD device 3. A cell gap d of the liquid crystal layer 33 is defined between two alignment films 314, 323. A ratio of the cell gap d of the liquid crystal layer 33 to a chiral pitch p is equal to or less than 0.25, that is, d/p≦0.25. Due to the chiral dopant, liquid crystal molecules of the liquid crystal layer 33 progressively twist along a helical pattern from each of the alignment films 314, 323 toward a center portion of the liquid crystal layer 33 halfway between the alignment films 314, 323. Thus, an alignment mode of the liquid crystal molecules when no voltage is applied to the LCD device 3 is a twist alignment.

During a transition process of rearranging the liquid crystal molecules from the twist alignment to a bend alignment, the liquid crystal molecules in the twist alignment can rapidly twist when a voltage is applied thereto. That is, the liquid crystal molecules initially in the twist alignment have a fast response time in the process of rearranging to the bend alignment. Therefore, a warm-up time to transform the liquid crystal molecules from the initial twist alignment to the bend alignment before normal display is relatively short.

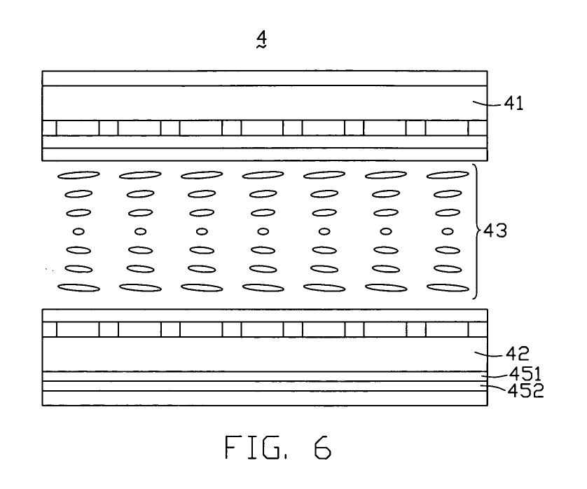

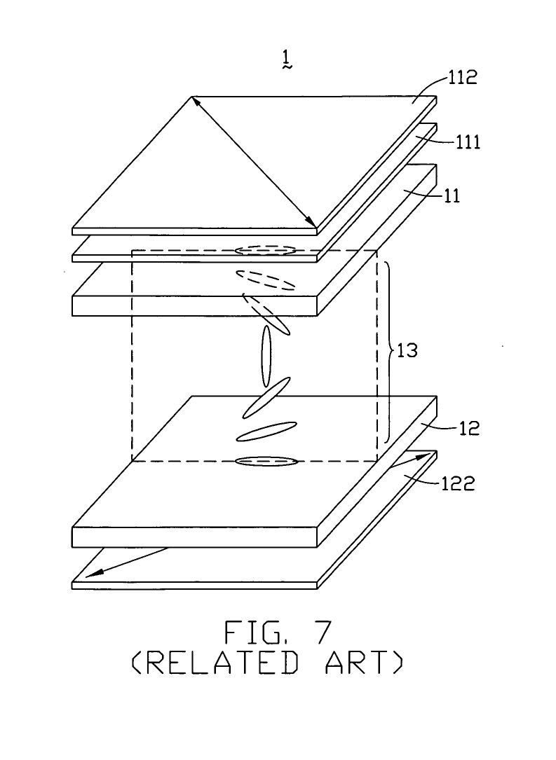

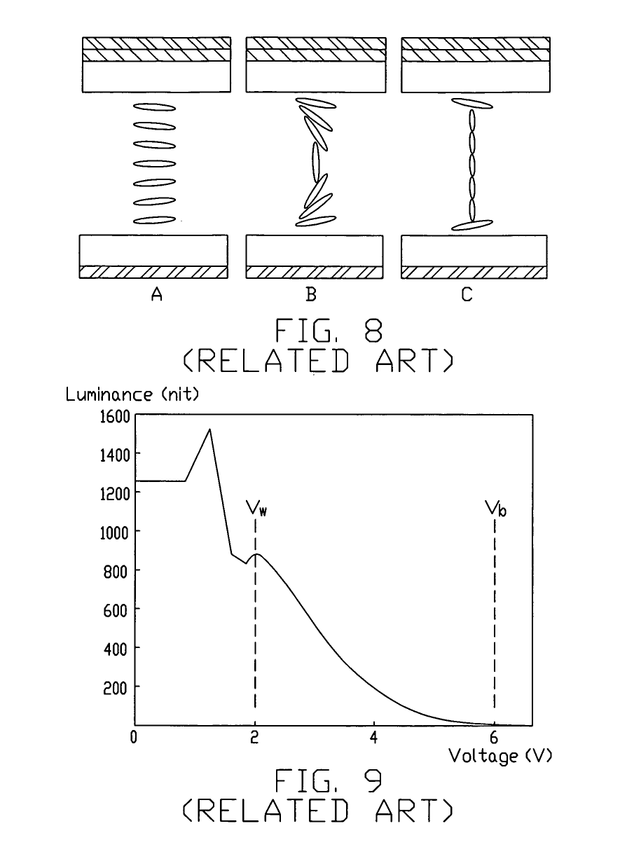

Referring to FIG. 6, an LCD device 4 of a third embodiment is similar to the LCD device 3, and the LCD device 4 employs the same driving method as the LCD device 3. However, the LCD device 4 further includes a first compensation film 451 and a second compensation film 452. The first and second compensation films 451, 452 are disposed on an outer surface of a second substrate 42 of the LCD device 4 far from a liquid crystal layer 43. The first compensation film 451 is a quarter wave plate, and the second compensation film 452 is a half wave plate. The first and second compensation films 451, 452 can improve both a ratio of utilization of polarized light and a viewing angle of the LCD device 4.

In alternative embodiments, either or both of the first and second compensation films 451, 452 can be replaced by one or more other compensation films, such as a uniaxial retardation film, an A-plate compensation film, a C-plate compensation film, a biaxial retardation film, a wide-band quarter wave plate, and so on. The first and second compensation films 451, 452 can be disposed on an outer surface of a first substrate 41 of the LCD device 4. One set of first and second compensation films 451, 452 can be disposed on the outer surface of each of the first and second substrates 41, 42.

It is to be further understood that even though numerous characteristics and advantages of the present embodiments have been set forth in the foregoing description with details of the structures and functions of the embodiments, the disclosure is illustrative only, and changes made in detail, including in matters of shape, size, and arrangement of parts within the principles of the embodiments to the full extent indicated by the broad general meaning of the terms in which the appended claims are expressed.

What is claimed is:

1. A liquid crystal display device that operates in optically compensated bend mode, the liquid crystal display device comprising:
a gate driving circuit;
a data driving circuit; and
a plurality of pixel units;
wherein the gate driving circuit is configured for providing a gate signal to each of the pixel units, and
the data driving circuit is configured for providing a first voltage corresponding to a black signal in a first sub frame of a frame divided into two sub frames to each of the pixel units via a corresponding data line, and a second voltage corresponding to a gray level display signal in a second sub frame of the frame to each of the pixel units.

2. The liquid crystal display device of claim 1, wherein the second voltage is in a range from 0V to the first voltage.

3. The liquid crystal display device of claim 1, wherein a black insertion ratio is defined as T_{b}/T_{f}, wherein, T_{f} represents a frame time and T_{b} represents a first sub frame time, and the ratio T_{b}/T_{f} is in a range from 15% to 50%.

4. The liquid crystal display device of claim 1, wherein a black insertion ratio is defined as T_{b}/T_{f}, wherein, T_{f} represents a frame time and T_{b} represents a first sub frame time, and the ratio T_{b}/T_{f} is in a range from 15% to 30%.

5. The liquid crystal display device of claim 1, wherein a black insertion ratio is defined as T_{b}/T_{f}, wherein, T_{f} represents a frame time and T_{b} represents a first sub frame time, and the ratio T_{b}/T_{f} is in a range from 15% to 20%.

6. The liquid crystal display device of claim 1, wherein the liquid crystal layer includes chiral dopant added therein.

7. The liquid crystal display device of claim 6, wherein a ratio of a cell gap of the liquid crystal layer to a chiral pitch is equal to or less than 0.25.

8. The liquid crystal display device of claim 1, further comprising a first compensation film and a second compensation film, wherein the first and second compensation films are disposed at an outer surface of the second substrate.

9. A method for driving a liquid crystal display device that operates in optically compensated bend mode, the liquid crystal display device comprising a plurality of pixel units, the method comprising:
applying a first voltage in a first sub frame of a frame divided into two sub frames to each of the pixel units; and
applying a second voltage in a second sub frame of the frame to each of the pixel units;
wherein the first voltage corresponds to a black signal, and the second voltage corresponds to a gray level display signal.

10. The method of claim 9, wherein the second voltage is in a range from 0V to the first voltage.

11. The method of claim 9, wherein a black insertion ratio is defined as T_{b}/T_{f}, wherein, T_{f} represents a frame time and T_{b} represents a first sub frame time, and the ratio T_{b}/T_{f} is in a range from 15% to 50%.

12. The method of claim 9, wherein a black insertion ratio is defined as T_{b}/T_{f}, wherein, T_{f} represents a frame time and T_{b} represents a first sub frame time, and the ratio T_{b}/T_{f} is in a range from 15% to 30%.

13. The method of claim 9, wherein a black insertion ratio is defined as T_{b}/T_{f}, wherein, T_{f} represents a frame time and T_{b} represents a first sub frame time, and the ratio T_{b}/T_{f} is in a range from 15% to 20%.

14. A liquid crystal display device that operates in optically compensated bend mode, the liquid crystal display device comprising:
two substrates;
a liquid crystal layer sandwiched between the two substrates;
a plurality of gate lines parallel to each other disposed at one of the two substrates;
a plurality of data lines parallel to each other disposed at the same substrate as the gate lines and intersecting the gate lines;
a plurality of pixel units defined by the intersecting gate lines and data lines; and
a data driving circuit electrically connected to the data lines;
wherein the data driving circuit is configured for providing a first voltage corresponding to a black signal in a first sub frame of a frame divided into two sub frames to each of the pixel units via a corresponding data line, and a second voltage corresponding to a gray level display signal in a second sub frame of the frame to each of the pixel units via the corresponding data line.

15. The liquid crystal display device of claim 14, wherein the second voltage is in a range from 0V to the first voltage.

16. The liquid crystal display device of claim 14, wherein a black insertion ratio is defined as T_{b}/T_{f}, wherein, T_{f} represents a frame time and T_{b} represents a first sub frame time, and the ratio T_{b}/T_{f} is in a range from 15% to 20%.

17. The liquid crystal display device of claim 14, wherein the liquid crystal layer includes chiral dopant added therein.

18. The liquid crystal display device of claim 17, wherein a ratio of a cell gap of the liquid crystal layer to a chiral pitch is equal to or less than 0.25.
